(19) United States
(12) Patent Application Publication
(10) Pub. No.: US 2026/0099429 A1
(43) Pub. Date: Apr. 9, 2026

(54) AUTOMATED MICROSERVICE TESTING

(71) Applicant: Hewlett Packard Enterprise Development LP, Spring, TX (US)

(72) Inventors: Hiro Rameshlal Lalwani, Bangalore (IN); Rachit Gupta, Bangalore (IN); Sherine Jacob, Bangalore (IN); Sagar Venkappa Nyamagouda, Bangalore (IN); Jayasankar Nallasamy, Bangalore (IN); Kumar Gaurav, Bangalore (IN); Charan Kumar Halelakya Lokesha, Bangalore (IN); Adhitya Kothandaraman, Bangalore (IN); Bhuvanesh K, Bangalore (IN)

(21) Appl. No.: 18/980,377

(22) Filed: Dec. 13, 2024

(30) Foreign Application Priority Data
Oct. 7, 2024 (IN) 202441075803

(51) Int. Cl. G06F 11/3668; G06N 20/00

(52) U.S. Cl. CPC G06F 11/368; G06F 11/3688; G06N 20/00

(57) ABSTRACT

A computer-implemented method and system can be used to test a code modification for a microservice application. The code modification is analyzed using a machine learning model trained on historical test run results and code change data, Based on the analysis, a subset of test cases relevant to the code modification are predicted and selected from a test case repository. The selected subset of test cases can be executed to test the code modification. If the test cases are stored in natural language, natural language processing can be used to determine actionable words and assign weightages from the test case information. Test scripts can be developed based on the determined actionable words and assigned weightages.

### BACKGROUND

Microservices are an architectural approach to software development where an application is built as a collection of small, independent services, each running in its own process and communicating with lightweight mechanisms. Testing microservices includes unit testing of individual services, integration testing of service interactions, end-to-end testing of complete workflows, and performance testing under various load conditions. Services can be updated, which leads to further testing.

### BRIEF DESCRIPTION OF THE DRAWINGS

For a more complete understanding of this disclosure, and advantages thereof, reference is now made to the following descriptions taken in conjunction with the accompanying drawings, in which:

FIG. 1 depicts a computer system 100 that represents functional operations

FIG. 2A depicts a computer network and FIG. 2B depicts a component, according to example implementations.

FIG. 3 depicts a computer system, according to example implementations.

FIG. 4 depicts a system in flow chart form, according to example implementations.

FIG. 5 depicts a flowchart of a computer-implemented method, according to example implementations.

FIG. 6 depicts a flowchart of a method of creating a machine learning model, according to example implementations.

FIG. 7 depicts components and workflow of an adaptive language processing engine, according to example implementations

FIG. 8 depicts a flow chart of a method of tokenization, according to example implementations

FIG. 9 depicts a flowchart 900 of a method developing a test script from natural language test case information, according to example implementations.

FIGS. 10A and 10B depict charts showing test results for example implementations.

### DESCRIPTION

The following disclosure provides many different examples for implementing different features. Specific examples of components and arrangements are described below to simplify the present disclosure. These are, of course, merely examples and are not intended to be limiting. Various implementations can be combined and features described with respect to one implementation may apply to others as would be known to one of skill in the art.

A microservices architecture enables the creation of large, complex applications as a suite of small, independently deployable services. This architecture, however, creates challenges in software testing. Microservice testing includes unit testing of individual services, integration testing of service interactions, end-to-end testing of complete workflows, and performance testing under various load conditions. The dynamic nature of microservices environments, where services can be updated or scaled independently, leads to continuous testing throughout the development lifecycle. In hybrid cloud environments, microservices may be deployed across both on-premises and cloud infrastructures.

A cloud environment presents challenges and opportunities for microservices testing. Containerization technologies facilitate consistent testing environments, while orchestration tools enable the simulation of production-like scenarios. Cloud providers offer various testing tools and services that can be leveraged to automate and scale testing processes. Performance testing in cloud environments can ensure services can handle varying loads and maintain responsiveness under different conditions. Security testing is implemented given the distributed nature of microservices and the potential vulnerabilities in cloud infrastructure.

Implementations disclosed herein relate to a computer system and methods for efficient testing of microservices in cloud computing environments. One example system comprises a distributed computing environment for deploying microservices and a test execution engine to implement codes changes. When a code modification is received for a microservice, the test execution engine analyzes it using the machine learning model to select and execute a relevant subset of test cases, rather than running all available tests.

The application also details methods for developing test scripts from natural language test case information. In an example implementation, this process involves using natural language processing to determine actionable words and assign weightages from the test case description. A test script is then developed based on these extracted elements and executed to test the microservice. The method can include generating tokens, querying a database to retrieve corresponding methods, and combining these methods to form the test script.

A machine learning model is utilized for predicting which test cases are most relevant to a given code modification. The model is trained on historical test run results and code change data. When a new code modification is received, the model analyzes it to predict and select a subset of relevant test cases from a repository. This approach aims to optimize the testing process by focusing on the most pertinent tests for each code change.

The application further describes the process of creating and training the machine learning model. This involves collecting and preprocessing historical data, selecting and training a machine learning algorithm, validating the trained model, and testing its predictive performance with new code changes. The model can be continuously updated based on comparisons between its predictions and actual test results, allowing for ongoing improvement in its ability to select relevant test cases.

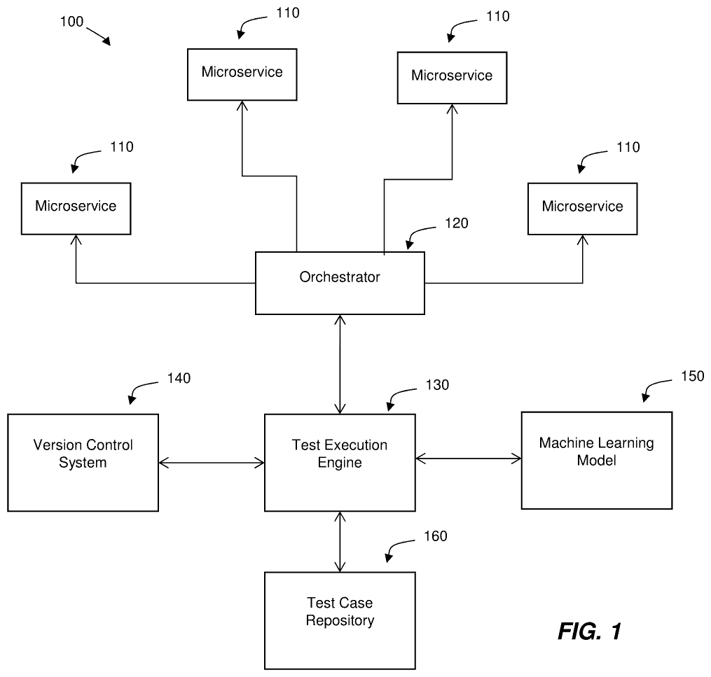

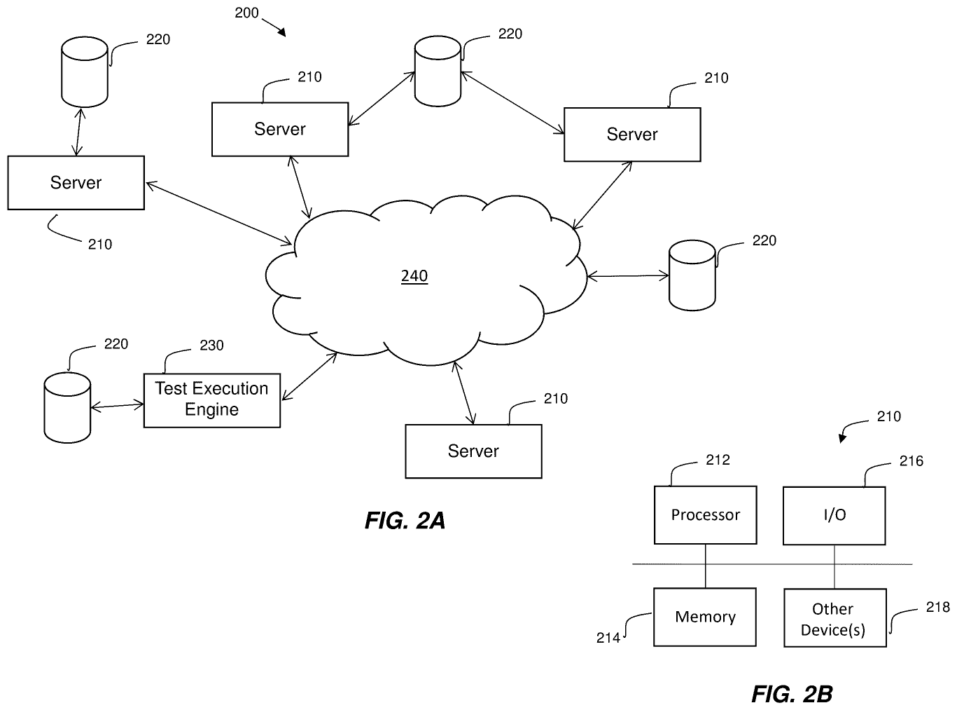

FIG. 1 depicts a computer system 100 that represents functional operations of a testing framework designed for microservice-based applications in a distributed computing environment. In this example, the system comprises several components that work together to streamline the testing process and enhance the efficiency of code modifications and deployments. A possible physical network implementation of the computer system is shown in FIG. 2.

The distributed computing environment 100 is configured to deploy a plurality of microservices 110. Microservices 110 are individual, specialized software components designed to perform specific functions within a larger cloud service. In an example implementation, each microservice 110 is a self-contained unit of code that can be developed, deployed, and scaled independently. These microservices may handle various tasks such as user authentication, data processing, or specific business logic. They can communicate with each other through defined APIs, allowing for a modular and flexible system architecture.

In this example, the microservices 110 interact with each other through an orchestrator 120, which manages the routing of requests and overall coordination between the microservices. The orchestrator 120 serves as a central management component for the microservices 110 along with other elements of the network. In an example implementation, the orchestrator 120 is responsible for coordinating interactions between microservices, routing requests to the appropriate services, and managing the overall flow of data and operations within the distributed system. It may employ service discovery mechanisms to locate and communicate with the various microservices, and it may also handle load balancing to ensure efficient resource utilization across the system.

The system incorporates a test execution engine 130, which is responsible for receiving code modifications for the microservices and initiating the appropriate testing procedures. In an example implementation, the test execution engine 130 receives code changes, interfaces with the machine learning model 150 to determine which tests to run, retrieves the relevant test cases from the test case repository 160, and executes these tests or provides the tests to be executed by a user or other component. It may also collect and analyze test results, providing feedback to developers and other system components about the success or failure of the tests.

Working in tandem with the test execution engine is a version control system 140, which manages code modifications for the microservices, e.g., to track and maintain versions of changes. In an example implementation, the version control system 140 may use Git or a similar distributed version control system. It stores different versions of the code, manages branches for feature development or bug fixes, and facilitates collaboration among multiple developers. The version control system 140 integrates with the test execution engine 130, providing it with information about code modifications that need to be tested.

A machine learning model 150 is integrated into the system 100. This model can be trained on historical test run results and code change data, allowing it to make predictions about which test cases are most relevant to specific code modifications. The machine learning model 150 analyzes incoming code changes and helps in selecting the most appropriate subset of test cases to run.

The machine learning model 150 is an intelligent component that analyzes code changes and predicts which test cases are most relevant. In an example implementation, the machine learning model 150 may use a decision tree classifier or another suitable algorithm. It is trained on historical data that includes past code changes, the tests that were run for those changes, and the outcomes of those tests. When a new code modification is received, the model analyzes the change and predicts which test cases are most likely to be affected, helping to optimize the testing process. Further detail on the learning model is provided below.

The system also includes a test case repository 160, which stores a comprehensive set of test cases. When a code modification is received, the test execution engine 130, in conjunction with the machine learning model 150, selects a subset of these test cases based on the analysis of the code modification. This selective approach to testing allows for more efficient use of resources and faster validation of code changes.

The test case repository 160 can be implemented as a storage system that stores the test cases for the microservices. In an example implementation, the test case repository 160 may be a database or a structured file system that stores test scripts, input data, expected outputs, and metadata about each test case. It may categorize test cases based on the microservices they target, the types of functionality they test, or other relevant criteria. The test execution engine 130 queries this repository to retrieve the specific test cases recommended by the machine learning model 150 for each code modification.

Test case information stored in the test case repository 160 might include historical data such as previous execution results, frequency of failures, and average execution time, which can be valuable for the machine learning model in predicting test relevance and prioritizing test execution. The test case information may also contain specific input data or preconditions required to set up the test environment so that the test can be executed accurately and consistently across different runs and environments. This comprehensive set of information enables the testing system to not only execute tests efficiently but also to make intelligent decisions about test selection and prioritization based on the current code changes and historical performance.

In an example implementation, when a developer submits a code modification for one of the microservices 110, the test execution engine 130 receives this modification. It then utilizes the machine learning model 150 to analyze the change and predict which test cases are most likely to be affected. Based on this analysis, the engine selects a subset of relevant test cases from the test case repository 160. These selected test cases are then executed to validate the code modification to that only the most pertinent tests are run for each change.

This targeted approach to testing microservices allows for rapid validation of code changes while maintaining high quality standards. It enables the system to adapt to the fast-paced nature of microservice development and deployment, supporting quick iterations and frequent updates to the cloud service.

FIG. 2A depicts a network that can utilize the system of FIG. 1, as well as later described examples. The system 200 comprises a network 240, multiple servers 210, and multiple storage units 220. A test execution engine 230 as described above is included as one of the components.

The network 240 interconnects the components of the system 200, enabling communication between the servers 210, storage units 220, and any other components connected to the network. This network-based architecture allows for distributed data processing and storage capabilities across multiple devices.

The network 240 can be representative of on-premises infrastructure, private cloud infrastructure, or public cloud infrastructure. Combinations of these can also execute the microservices disclosed herein. For example, an on-premises infrastructure can include physical hardware and software resources located within an organization's premises, managed and maintained internally rather than hosted on external cloud services. Private cloud infrastructure can include a cloud computing environment dedicated to a single organization, while public cloud infrastructure can include computing services provided by third-party vendors over the internet.

The network 240 facilitates data exchange and coordination between the servers 210 and storage units 220 and any other compute resources associated with the network. In various implementations, the network 240 can be implemented as a cloud-based service. The network 240, however, is not limited to cloud implementations. It may also be realized as a local area network (LAN), wide area network (WAN) such as the Internet, a virtual private network (VPN), or a combination of these technologies. The network 240 can utilize various communication protocols and security measures to ensure reliable and secure data transmission.

The servers 210 are computing devices that interact with the storage units 220 via the network 240 or outside the network. In one or more embodiments, the servers 210 execute specific tasks as directed by an orchestrator, such as data processing, temporary storage, or data transfer operations.

The storage units 220 provide persistent data storage for the system 200. These units may be directly connected to the network 240 or accessed through the servers 210. The storage units 220 can be implemented using a variety of technologies, such as solid-state drives (SSDs) for high-speed data access, hard disk drives (HDDs) for cost-effective bulk storage, or a combination of both to balance performance and capacity. Long term storage can utilize tape drive storage. The storage units 220 may utilize network-attached storage (NAS) devices, storage area network (SAN) systems, or object storage platforms for scalable and flexible data management. In an example implementation, the storage units 220 can incorporate redundant array of independent disks (RAID) configurations to enhance data reliability and fault tolerance.

The servers 210 and storage units 220 are meant to be representative of the various compute resources that are interconnected by network 240. The compute resources can include computing power (virtual machines or serverless functions), storage capacity (object storage, file systems, or databases), networking infrastructure (load balancers, virtual private networks), and various platform services (e.g., machine learning, analytics, Internet of Things devices), as examples.

The configuration depicted in FIG. 2A is just one example. The system 100 can be adapted based on operational requirements. For example, the system 100 can be implemented in various computing environments, including on-premises data centers, cloud infrastructures, or hybrid setups.

FIG. 2B illustrates a simplified architecture of any of the servers 210. The server 210 in this example includes a processor 212, a memory 214, input/output 216, and a notation for other devices 218. It is understood that the processing discussed herein can be performed by a single computer (e.g., server) 210 or distributed across a number of computers.

Test execution engine 230 is one of the elements illustrated in FIG. 2A. This inclusion is intended to illustrate that the functional components described with respect to FIG. 1 can be implemented by a device or devices connected to the network. For example, this functionality can be performed by a single processor 212, a number of processors 212 within a single machine, or distributed amongst a number of machines in the network.

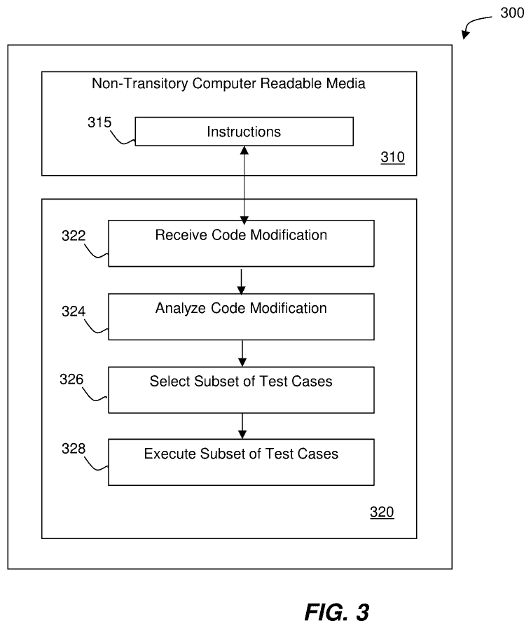

FIG. 3 depicts a computer system 300 that can be used to implement the test execution engine, in an example implementation. The system 300 includes one or more processors 320 and a non-transitory computer readable memory 310. Again, these elements can be within a single device or distributed among a number of devices. The memory 310 stores instructions that, when executed by the one or more processors, cause the processor(s) 320 to perform steps as disclosed here. In this particular example, the processor(s) 320 are programmed to receive a code modification (322), analyze the code modification (324), select a subset of test cases (326), and execute the subset of test cases (328). Other methods disclosed herein can be implemented with a similar system.

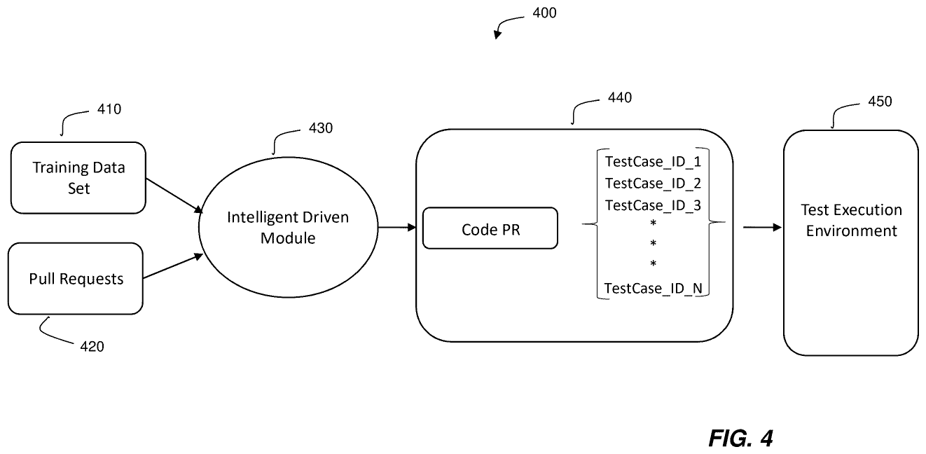

A particular example will now be discussed with reference to FIG. 4, which depicts a machine learning-driven test recommendation model 400. This model is designed to optimize the testing process by predicting and selecting the most relevant test cases for each code modification.

The system includes a training data set 410. In an example implementation, this dataset comprises historical information including past code changes, the test cases that were executed for those changes, and the outcomes of those tests. This historical data is used for training the machine learning model to recognize patterns and make accurate predictions.

The pull requests component 420 represents the input of new code modifications into the system. In an example implementation, when developers submit changes to the microservices, these changes are captured as pull requests in the version control system.

The intelligent driven module 430 contains the machine learning model, which may be a decision tree classifier or another suitable algorithm. The intelligent driven module 430 is trained using the training data set 410 and processes the incoming pull requests 420.

One example utilizes a decision tree classifier, which implements a machine learning algorithm used for both classification and regression tasks. In an example implementation within the context of the microservices testing system, it operates by creating a tree-like model of decisions based on features of the input data. The tree includes nodes representing decision points, branches representing possible outcomes of those decisions, and leaf nodes representing final classifications or predictions. When analyzing a code modification, the decision tree classifier would start at the root node and traverse down the tree, making decisions at each internal node based on specific attributes of the code change. These attributes might include the files modified, the type of change (e.g., addition, deletion, modification), or the specific functions or modules affected. At each decision point, the tree splits the data based on the feature that provides the most information gain, effectively separating the data into increasingly homogeneous subsets. This process continues until a leaf node is reached, which provides the final prediction—in this case, which test cases are most likely to be relevant to the code change.

While the decision tree classifier is a suitable algorithm for the machine learning model in the microservices testing system, several other algorithms could also be effectively employed. Each of these alternatives has its own strengths and characteristics that might make it appropriate depending on the specific requirements and constraints of the system.

Random forest is an ensemble learning method that constructs multiple decision trees and combines their outputs for improved prediction accuracy. In an example implementation, it could be used to analyze code changes by creating numerous decision trees, each trained on a subset of the historical data and features. The final prediction of relevant test cases would be based on the consensus of these trees. This approach often provides better generalization and is less prone to overfitting compared to a single decision tree.

Support vector machines (SVM) is another algorithm that could be applied to this problem. In an example implementation, SVM could map the features of code changes into a high-dimensional space and find the optimal hyperplane that separates different classes of test cases. SVM can be particularly effective when dealing with complex, non-linear relationships between features and outcomes, which could be beneficial when analyzing intricate code dependencies.

Gradient boosting machines, such as XGBoost or LightGBM, are iterative algorithms that build a series of weak learners (typically decision trees) and combine them into a strong predictor. In an example implementation, these algorithms could incrementally improve their predictions of relevant test cases by focusing on the errors of previous iterations. Gradient boosting often provides high accuracy and can handle a mix of feature types, which could be advantageous when dealing with various aspects of code changes.

Neural networks, e.g., deep learning models, could also be applied to this task. In an example implementation, a neural network could be designed with multiple layers to capture complex patterns in the relationship between code changes and relevant test cases. This approach could be especially powerful when dealing with large amounts of historical data and when the relationships between code changes and test cases are highly non-linear or difficult to express with simpler models.

K-nearest neighbors (KNN) is a non-parametric algorithm that could be used for this task. In an example implementation, KNN would classify a new code change by comparing it to the most similar historical changes in the training data. The test cases associated with these similar changes would then be recommended. This approach can be effective when the relationship between code changes and test cases is complex and not easily captured by a set of rules.

Naive Bayes is a probabilistic algorithm based on Bayes' theorem. In an example implementation, it could calculate the probability of each test case being relevant given the features of a code change. While it makes strong independence assumptions between features, naive Bayes can be effective, especially when dealing with a large number of features relative to the number of training examples.

Each of these algorithms has its own trade-offs in terms of interpretability, training time, prediction speed, and performance with different types and amounts of data. The choice of algorithm would depend on factors such as the size and nature of the codebase, the number and complexity of test cases, the available computational resources, and the specific requirements for explanation and interpretability of the predictions.

The output of the intelligent driven module 430 is represented by the code prediction 440 component. This component, in an example implementation, contains the analyzed code changes along with predictions about which test cases are most likely to be affected by these changes. The system then produces a list of recommended test cases, represented in the figure as TestCase_ID_1, TestCase_ID_2, TestCase_ID_3, up to TestCase_ID_N. These are the specific test cases that the intelligent driven module 430 has determined are most relevant to the code changes in the current pull request.

Finally, the selected test cases are sent to the test execution environment 460. In an example implementation, this environment is responsible for actually running the selected tests. It may include various platforms such as on-premises infrastructure, private cloud, or public cloud environments, depending on the specific requirements of each test case.

This machine learning-driven approach allows for a more efficient and targeted testing process. By predicting which test cases are most likely to be affected by specific code changes, the system can significantly reduce the time and resources required for testing, while still maintaining high quality standards and thorough coverage of potential issues.

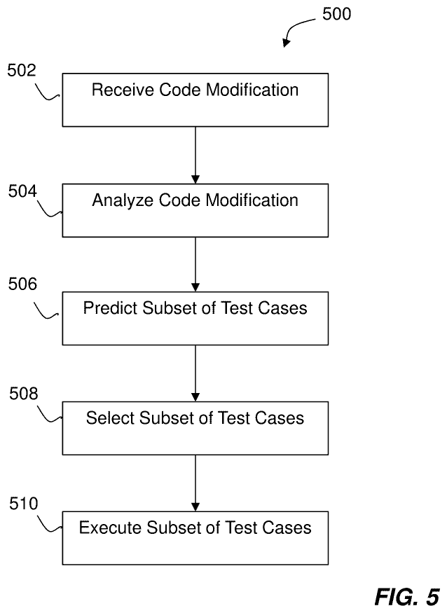

FIG. 5 depicts a flowchart 500 of a computer-implemented method according to example implementations. In step 502, a code modification is received for a microservice application. The code modification can be analyzed, e.g., using a machine learning model (step 504). In one example, the machine learning model is a decision tree classifier, which was trained, e.g., on historical test run results and code change data as discussed above. As an example, the code modification can be analyzed by identifying code paths affected by the code modification and determining functional areas of the microservice application associated with the affected code paths.

Based on the analysis, a subset of test cases relevant to the code modification can be predicted (step 506). This subset of test cases can then be selected from a test case repository (step 508) and executed to test the code modification (step 510). Results of executing the selected subset of test cases can be compared with predicted outcomes from the machine learning model. The machine learning model can then be updated based on the comparison.

As noted above, the execution environment for each test case can be one or combinations of on-premises infrastructure, private cloud infrastructure, or public cloud infrastructure.

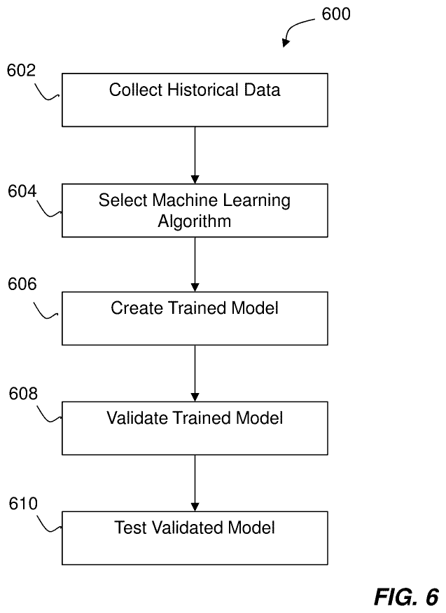

FIG. 6 depicts a flowchart 600 of a method of creating a machine learning model, according to example implementations. To begin, historical data is collected (step 602) and a machine learning algorithm is selected for the model (step 604). For example, the historical data can include code changes from a version control system, past test cases executed in response to the code changes, code paths exercised by the executed test cases, and outcomes of the past test cases. The historical data can be preprocessed by extracting features from the code changes, mapping the extracted features to past test cases, and labeling the mapped features with outcomes of the past test cases.

The selected machine learning algorithm is trained using the historical data to create a trained model (step 606). For example, the training can include inputting extracted features from code changes from a version control system, comparing predicted relevant test cases with actually executed test cases, and adjusting model parameters based on the comparing. The trained model is validated using a subset of the historical data, e.g., data that was reserved for validation (step 608). The validated model can then be tested with new code changes to assess predictive performance (step 610).

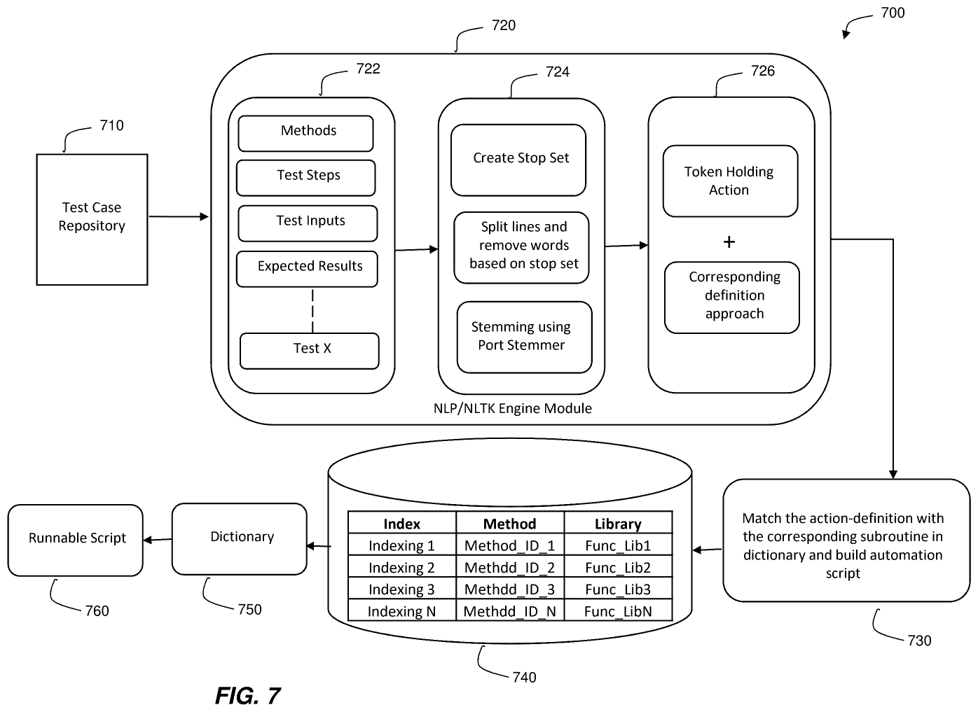

FIG. 7 relates to a different aspect of the disclosure, namely, the automation of the development of the test scripts such as those stored in the test case repository 160. The example of FIG. 1 assumes that the test cases are stored as executable code. In some cases, however, the test cases can be stored as natural language (e.g., English language) text. The system 700 can be implemented as an adaptive language processing engine to convert the natural language test case information to executable code. This system can be implemented using hardware and software resources as discussed herein.

The adaptive language processing engine is a component of the microservices testing system that leverages natural language processing (NLP) and Natural Language Toolkit (NLTK) libraries to automate the creation of test scripts from natural language descriptions. In an example implementation, this engine processes test cases written in plain English, typically, but not necessarily, sourced from repositories such as TestRail, JIRA, or Confluence. It employs techniques such as tokenization, stop word removal, and lemmatization to extract meaningful information from the text.

The engine can identify action words, weightages, and input parameters within the test case descriptions. For instance, in a test case stating “create 10 snapshots of a VM,” the engine would recognize “create” as the action, “snapshot” as the entity, “10” as the weightage, and “VM” as the input parameter. (VM stands for virtual machine.) These extracted elements are then used to form a query that interfaces with a database containing pre-defined methods and libraries. The engine matches the extracted information with the appropriate methods and generates executable test scripts. This process can significantly reduce the time and effort required to translate human-written test cases into automated scripts, enabling faster and more efficient testing cycles for microservices.

FIG. 7 illustrates an example of the components and workflow of an adaptive language processing engine 700, which is designed to automate the creation of executable test scripts from natural language test descriptions. The system comprises several interconnected components that work in concert to process and convert test case descriptions into runnable automation scripts for microservice testing.

In an example implementation, the process begins with a test case repository 710. This repository serves as the source of natural language test case information, containing test cases written in plain English that describe various testing scenarios for microservices. The test cases may be stored in various formats and platforms, such as word documents, spreadsheets, or specialized test management tools.

For example, a relational database management system (RDBMS) such as PostgreSQL or MySQL can be used to store the structured data of test cases. Each test case can be represented as a record in the database, with fields for various attributes such as test case ID, description, expected results, associated microservice, and metadata like creation date and last modified date. The database schema can be designed to support efficient querying and filtering of test cases based on different criteria.

To handle the actual content of test cases, which may include lengthy descriptions, input data, or even scripts, a document-oriented database like MongoDB can be employed. This allows for flexible storage of unstructured or semi-structured data associated with each test case. By integrating with a version control system (e.g., Git), the repository can maintain a history of changes to test cases, allowing for tracking of modifications, rollbacks if necessary, and collaboration among team members. This integration can be implemented by storing test case files in a Git repository and using Git hooks to update the database whenever changes are committed.

The repository can also implement a tagging system, allowing test cases to be categorized based on various attributes such as the type of test (e.g., unit, integration, end-to-end), the feature being tested, or the priority level. This facilitates easier organization and retrieval of relevant test cases. An API layer can be built on top of this storage system, providing standardized methods for creating, reading, updating, and deleting test cases. This API can be used by both the adaptive language processing engine to access test case descriptions and by the test execution engine to retrieve the test cases it needs to run.

The central component of the system is the NLP/NLTK Engine Module 720, which processes the natural language input from the test case repository 710. This module performs several crucial operations to prepare the input for further processing.

The NLP/NLTK engine module 720 can be used to process the natural language test cases. This module employs several techniques to extract meaningful information from the text. For the purpose of this discussion, the module 720 will be discussed in terms of sub-modules. The physical implementation of the module 720 can be any of the computer based technologies discussed herein.

Sub-module 722 module represents the collection of the test case information from the test case repository. These test case information can include various elements such as methods, test steps, test inputs, and expected results, The “Test X” box is included to represent additional test parameters.

In an example implementation, each test case retrieved from the repository contains a set of data designed to facilitate comprehensive testing. This information typically includes a unique identifier for the test case, allowing for easy tracking and reference throughout the testing process. The test case description, written in natural language, outlines the specific scenario or functionality to be tested. This description serves as the input for the adaptive language processing engine. The test case data also includes the expected results, which are can be used for determining whether the test passes or fails when executed. Each test case also contains metadata such as the associated microservice or component, the type of test (e.g., unit, integration, or end-to-end), and tags or categories for easy filtering and organization. The repository may also provide information about test dependencies, allowing the system to determine the optimal order of test execution.

Sub-module 724 relates to the creation of a set of common words (stop words) that will be removed from the text to focus on the most important terms. Stop words are common words (such as, e.g., “the,” “is,” “at,” “which”) that do not carry significant meaning for the purpose of test case interpretation. The stop set can be customized for the specific domain of microservice testing. The text is split into individual words and the stop words are removed, to help to isolate the key terms and phrases that are relevant to the test case.

Stemming can be used to reduce words to their root form, helping to standardize variations of the same word. A stemming algorithm, e.g., a port stemmer, is applied to reduce words to their root form. For example, “creating,” “created,” and “creates” would all be reduced to the stem “create.” This step helps to standardize the vocabulary and improve matching accuracy in subsequent steps.

In sub-module 726, the refined information moves to token holding action. In this stage, the system identifies actionable words and their corresponding definitions. Actionable words are terms that indicate specific operations or actions to be performed in the test case, such as “create,” “verify,” or “delete.” The corresponding definitions provide context or parameters for these actions.

In module 730, the action-definition is matched with the corresponding sub-routine in a dictionary so that the automation script can be built. In example implementations, the automation script is a set of programmed instructions that automate the process of testing a software application. They are designed to execute test cases automatically, without manual intervention. These scripts typically contain a series of commands, function calls, and assertions that mimic user actions and verify expected outcomes. The scripts can be written in programming languages compatible with testing frameworks, such as Python, Java, or specialized scripting languages for testing tools.

Storage unit 740 contains a library that contains mappings between indexing identifiers and corresponding method IDs and function libraries. It serves as a lookup table for matching processed tokens to specific functions or methods in the testing framework. The library 740 may be continuously updated and expanded to accommodate new testing scenarios and microservice functionalities.

Working in conjunction with the library 740 is a dictionary component 750. The dictionary 780 stores the actual methods or functions that correspond to the indexed information in the library 740. It serves as a repository of executable code snippets or function definitions that can be assembled into the final automation script. When the system matches action-definitions from the processed natural language input, it uses the library 740 to find the appropriate method IDs, which are then used to retrieve the corresponding subroutines or functions from the dictionary 740.

Finally, the system outputs a runnable script as shown by module 760. This is the executable test script that can be used to test the microservice. The runnable script is typically in a programming language or format that is compatible with the testing framework used for microservice testing.

This adaptive language processing engine enables rapid conversion of natural language test cases into automated test scripts. By leveraging natural language processing techniques and a well-structured method library, the system significantly reduces the time and effort required for test automation in microservice environments. This approach allows testers to focus on describing test scenarios in natural language, while the system handles the complexities of translating these descriptions into executable scripts.

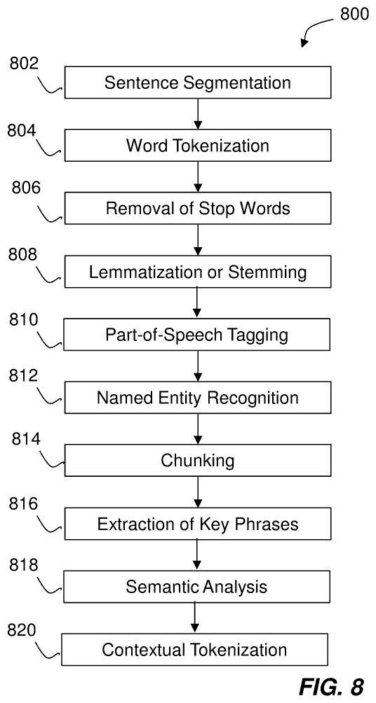

An example of a method for tokenization is depicted in the flowchart of FIG. 8. The example can be implemented as a step in the natural language processing of test cases within the adaptive language processing engine.

Step 802 depicts sentence segmentation. The first step is to break down the test case description into individual sentences. This is typically done using punctuation marks and line breaks as delimiters. For instance, the description “Create a new user account. Verify login credentials.” would be split into two separate sentences.

Step 804 depicts word tokenization. Each sentence is then further divided into individual words or tokens. This process might consider spaces as the primary delimiter but also accounts for contractions, hyphenated words, and special characters. For example, “Create a new user-account” might be tokenized into [“Create,” “a,” “new,” “user-account”].

Step 806 depicts the removal of stop words. Common words that don't carry significant meaning in the context of test cases (such as, e.g., “a,” “the,” “is,” “are”) are removed from the token list. This step helps focus on the most important words in the description. After this step, this example might become [“Create,” “new,” “user-account”].

Step 808 depicts lemmatization or stemming. To standardize words and reduce them to their base or root form, either lemmatization or stemming can be applied. Lemmatization considers the context and part of speech of the word to determine its lemma. Stemming, on the other hand, uses a simpler algorithm to remove word endings. For instance, “creating” might be lemmatized to “create.”

Step 810 depicts part-of-speech tagging. Each remaining token is tagged with its part of speech (e.g., noun, verb, adjective, etc.). This information is used to understand the role of each word in the test case description. In the example, “create” would be tagged as a verb, “new” as an adjective, and “user-account” as a noun.

Step 812 depicts named entity recognition. This step identifies and classifies named entities in the text into predefined categories such as person names, organizations, locations, or in the context of software testing, specific technical terms, component names, or data types.

Step 814 depicts chunking. Related tokens can then grouped together into “chunks” based on grammatical rules. For instance, “new user-account” might be chunked together as a noun phrase.

Step 816 depicts the extraction of key phrases. Based on the chunking and part-of-speech information, key phrases that represent actions, objects, or conditions in the test case are extracted. In the example, “Create user-account” might be extracted as a key phrase.

Step 818 depicts semantic analysis. The engine attempts to understand the meaning and intent behind the tokenized words and phrases. This could involve mapping tokens to predefined concepts or actions within the testing domain.

Step 820 depicts contextual tokenization. The engine may also consider the context of the entire test case and the specific domain of microservices to interpret certain tokens. For example, “user” might be recognized as a specific entity type within the system being tested.

The resulting tokenized and processed text provides a structured representation of the test case description, which can then be used to match with corresponding test scripts or to generate new automated tests. This tokenization process enables the system to bridge the gap between natural language descriptions and executable test code, facilitating efficient and accurate test automation.

Here, the remaining words are categorized into actions and their corresponding definitions. In an example implementation, this stage identifies key operations (actions) and their associated parameters or conditions.

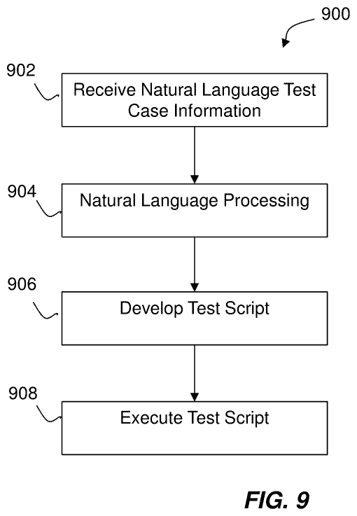

FIG. 9 depicts a flowchart 900 of a method developing a test script from natural language test case information, according to example implementations. The test case information can be developed for testing a microservice. In step 902, this information is received by the entity developing the executable scripts.

Natural language processing is used to determine actionable words and assign weightages from the test case information (step 904). For example, the natural language processing can include identifying stop words in the test case information and removing the identified stop words from the test case information prior to determining the actionable words. The assigned weightages can be determined by determining a numerical value for terms in the natural language test case information based on a determined importance of each term.

In step 906, a test script can be developed based on the determined actionable words and assigned weightages. In one implementation, the test script is developed by generating tokens based on the determined actionable words and assigned weightages, querying a database using the generated tokens to retrieve corresponding methods, and forming the test script by combining the retrieved corresponding methods. The database can include a mapping of operations to the corresponding methods in a testing framework.

In this manner a set of test scripts can be developed for a given microservice. In some cases, the set might include twenty or so different scripts. These test scripts can then be executed to test the microservices in question (step 908). As discussed above, only a subset of the test scripts need to be executed when only a portion of the code has changed. The code change can be analyzed to determine, e.g., select or develop, relevant natural language test cases. These selected test cases can be processed as discussed herein and executed to test the changed microservice code.

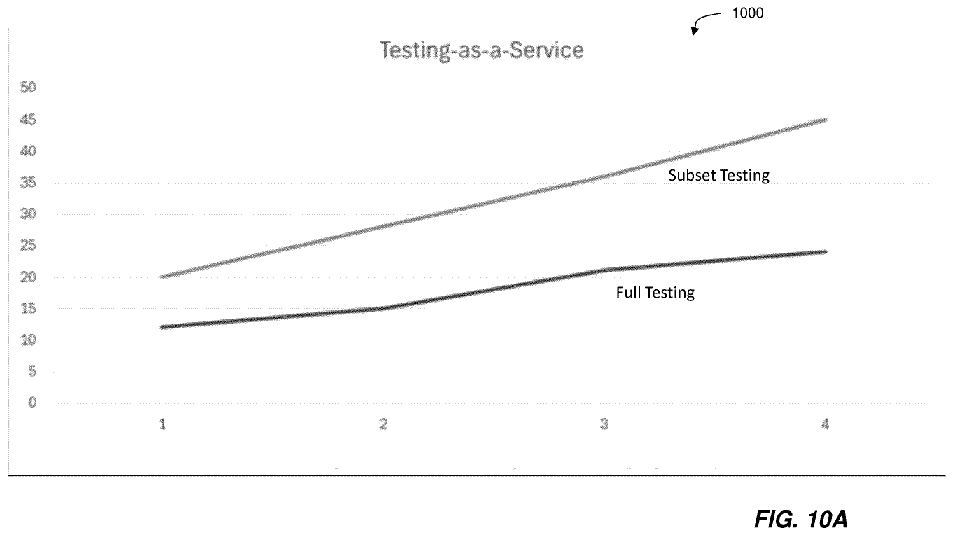

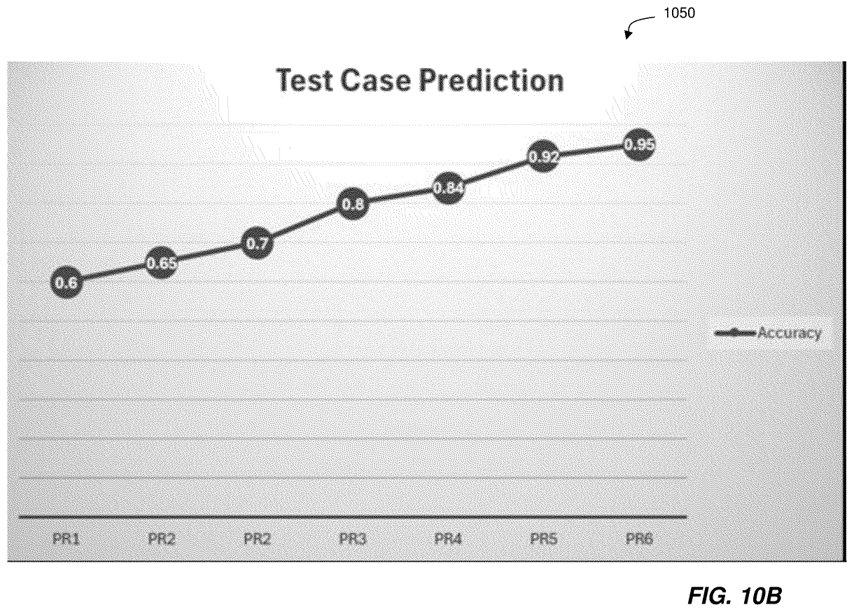

FIGS. 10A and 10B depict charts 1000 and 1050 showing test results for example implementations. Referring first to FIG. 10A, a proof of concept was performed to see if the automated generation of test scripts could be used, for example, as a testing-as-a service offering. The automation framework was tested with a variety of use cases. Methods discussed herein were used to auto-generate ready-made, runnable scripts. The use cases covered various components used in hybrid cloud data services and cloud management services. As shown in chart 1000, the subset testing provided a 60% increase in efficiency compared to traditional full testing methods.

As shown in FIG. 10B, the test case prediction algorithm was validated by accurately predicting test cases aligned with code changes. Approximately 30-40 automated test cases were generated, achieving nearly 100% test coverage and defect containment, with about a 70% reduction in effort and about a 60% increase in productivity. Chart 1050 shows how each PR is accurately predicted, determining the corresponding code changes and the tests required to validate them.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

What is claimed is:

1. A computer system comprising:
a distributed computing environment configured to deploy a plurality of microservices, each microservice configured to perform a function of a cloud service;
a version control system configured manage code modifications for the microservices;
a machine learning model trained on historical test run results and code change data;
a test case repository storing a plurality of test cases; and
a test execution engine configured to
receive a code modification for one of the microservices;
analyze the code modification using the machine learning model; and
select a subset of the test cases from the test case repository based on the analysis of the code modification, the selected subset of test cases being executable to test the received code modification.

2. The computer system of claim 1, wherein the distributed computing environment is configured to deploy updated microservices based on successful test results from the executed subset of test cases.

3. The computer system of claim 1, further comprising an orchestration layer configured to manage interactions between the microservices and route requests to appropriate microservices.

4. The computer system of claim 1, wherein the machine learning model comprises a decision tree classifier.

5. The computer system of claim 1, wherein the distributed computing environment comprises on-premises infrastructure, private cloud infrastructure, and public cloud infrastructure.

6. A computer-implemented method comprising:
receiving natural language test case information for testing a microservice;
using natural language processing to determine actionable words and assign weightages from the test case information;
developing a test script based on the determined actionable words and assigned weightages; and
executing the test script to test the microservice.

7. The method of claim 6, wherein developing the test script comprises:
generating tokens based on the determined actionable words and assigned weightages;
querying a database using the generated tokens to retrieve corresponding methods; and
forming the test script by combining the retrieved corresponding methods.

8. The method of claim 7, wherein the database comprises a mapping of operations to the corresponding methods in a testing framework.

9. The method of claim 6, wherein using the natural language processing comprises:
identifying stop words in the test case information; and
removing the identified stop words from the test case information prior to determining the actionable words.

10. The method of claim 6, wherein the assigned weightages are determined by determining a numerical value for terms in the natural language test case information based on a determined importance of each term.

11. The method of claim 6, further comprising:
receiving a code change associated with a software application;
analyzing the code change to determine relevant test cases; and
selecting the natural language test case information for processing based on the determined relevant test cases.

12. A computer-implemented method comprising:
receiving a code modification for a microservice application;
analyzing the code modification using a machine learning model trained on historical test run results and code change data;
predicting, based on the analyzing, a subset of test cases relevant to the code modification;
selecting the subset of test cases from a test case repository; and
executing the selected subset of test cases to test the code modification.

13. The method of claim 12, wherein the machine learning model comprises a decision tree classifier.

14. The method of claim 12, wherein analyzing the code modification comprises:
identifying code paths affected by the code modification; and
determining functional areas of the microservice application associated with the affected code paths.

15. The method of claim 12, further comprising:
receiving results of executing the selected subset of test cases;
comparing the received results with predicted outcomes from the machine learning model; and
updating the machine learning model based on the comparing.

16. The method of claim 12, further comprising determining an execution environment for each test case in the selected subset of test cases, wherein the execution environment is selected from the group consisting of on-premises infrastructure, private cloud infrastructure, and public cloud infrastructure.

17. The method of claim 12, further comprising creating the machine learning model, wherein the creating comprises:
collecting historical data;
selecting a machine learning algorithm for the model;
training the selected machine learning algorithm using the historical data to create a trained model;
validating the trained model using a subset of the historical data reserved for validation; and
testing the validated model with new code changes to assess predictive performance.

18. The method of claim 17, wherein the historical data comprises:
code changes from a version control system;
past test cases executed in response to the code changes;
code paths exercised by the executed test cases; and
outcomes of the past test cases.

19. The method of claim 17, further comprising preprocessing the collected historical data, the preprocessing comprising:
extracting features from the code changes;
mapping the extracted features to past test cases; and
labeling the mapped features with outcomes of the past test cases.

20. The method of claim 19, wherein the training comprises:
inputting extracted features from code changes from a version control system;
comparing predicted relevant test cases with actually executed test cases; and
adjusting model parameters based on the comparing.
